(19) United States
(12) Patent Application Publication
(10) Pub. No.: US 2019/0040504 A1
(43) Pub. Date: Feb. 7, 2019

(54) PARTICULATE FOR ADDITIVE MANUFACTURING TECHNIQUES

(71) Applicant: Hamilton Sundstrand Corporation, Charlotte, NC (US)

(72) Inventors: William L. Wentland, Rockford, IL (US); Eric W. Karlen, Rockford, IL (US)

(21) Appl. No.: 16/154,545

(22) Filed: Oct. 8, 2018

Related U.S. Application Data
(62) Division of application No. 14/738,474, filed on Jun. 12, 2015.

(51) Int. Cl. C22C 21/16; B33Y 70/00

(52) U.S. Cl. CPC C22C 21/16; B33Y 70/00

(57) ABSTRACT

A particulate feedstock for an additive manufacturing process includes particles formed from an aluminum base alloy. The alloy includes both aluminum and copper, and the amount of aluminum in the alloy is greater than the amount of copper in the alloy as a percentage of total weight. The alloy also includes at least one other material including at least one of magnesium manganese, titanium, nickel, and boron. The amount of copper in the alloy is greater than the amounts of each of the magnesium, manganese, titanium, nickel, and/or boron included in the alloy to render the particulate amenable to high energy density joining techniques.

### BACKGROUND OF THE INVENTION

### 1. Field of the Invention

The present disclosure relates to additive manufacturing, and more particularly to aluminum alloy particulates for additive manufacturing techniques.

### 2. Description of Related Art

Aircraft commonly include structures fabricated from aluminum or aluminum alloys. Structure formed of such materials are generally formed using casting, forging, or material removal processes because such materials can present challenges to conventional joining techniques such as welding. This is because the material forming the joint, such as a welded or fused portion, can have mechanical properties that differ from portions of the structures outside of the joint. This tendency can also render such alloys unsuitable for some additive manufacturing techniques where, in contrast to casting, forging, and traditional “subtractive” manufacturing methods, structures are formed by progressively adding new material to an existing structure. The new material is commonly fused to the existing structure (or substrate) by selectively fusing new material according to the geometry of an intended structure. Certain materials including aluminum and aluminum alloys may also present challenges to such additive manufacturing techniques because fused portions can have mechanical properties that differ from the mechanical properties of structures formed using conventional fabrication techniques.

Such conventional structures and methods of making such structures have generally been considered satisfactory for their intended purpose. However, there is still a need in the art for improved aluminum-containing structures and methods of making such structures. The present disclosure provides a solution for this need.

### SUMMARY OF THE INVENTION

A particulate feedstock for an additive manufacturing process includes particles formed from an aluminum (Al) base alloy. The Al base alloy includes an amount of Al and an amount of copper (Cu). The amount of Al is greater than the amount of Cu as a percentage of total weight. The alloy also includes an amount of another element including at least one of magnesium (Mg), manganese (Mn), titanium (Ti), nickel (Ni), and boron (B). The amount of the at least one other element of Mg, Mn, Ti, Ni and B is less than the amount of Cu as a percentage of total weight such that, when joined using a welding or a fusing process, the joint has at mechanical properties substantially the same or better than Alloy 2219.

In certain embodiments, the Al base alloy can include an amount of Mg or Mn that is less than the amount of Cu. The Al base alloy can include both Mg and Mn, and each of the amounts of Mg and Mn can be less than the amount of Cu. The amount of Mg can be a non-trace amount of Mg, and the amount of Mn can be smaller or greater than the amount of Mg. The amount of Cu can be between 5% and 6.5% by weight. The amount of Mg can be less than 0.3% by weight. The amount of Mn can be between 0.2% and 1% by weight.

In accordance with certain embodiments, the Al base alloy can include an amount of Ti. The amount of Ti can be less than the amount of Cu. The Al base alloy can include amounts of both Mg and Ti, and the amount of Ti can greater than or less than the amount of Mn. The Al base alloy can include both Mn and Ti, and the amount of Ti can be greater than or less than the amount Mn. It is contemplated that the amount of Ti included in the Al base alloy can be can be in the range of 0.15% and 0.5% by weight.

It is also contemplated that, in accordance with certain embodiments, the Al base alloy can include an amount of Ni. The amount of Ni can be less than the amount of Cu. The Al base alloy can include amounts of both Ni and Mg, and the amount of Ni can be greater than or less than the amount of Mg. The Al base alloy can include amounts of both Ni and Mn, and the amount of Ni can be greater than or less than the amount Mn. The Al base alloy can include amounts of both Ni and Ti, and the amount of Ni can greater than or less than the amount of Ti the amount of Ni can be between 0.1% and 0.5% by weight.

It is further contemplated that the Al base alloy can include an amount of B. The amount of B can be less than the amount of Cu. The Al base alloy can include amounts of both B and Mg, and the amount of B can greater than or less than the amount of Mg. The Al base alloy can include amounts of both B and Mn, and the amount of B can be less than the amount of Mn. The amount of B can be 0.01% and 0.03% by weight.

In an aspect, an Al base alloy includes amounts of Al, Cu, Mg, Mn, Ti, Ni, and B. The amount of Cu is between 5% and 6.5% by weight, the amount of Mg is less than 0.3% by weight, the amount of Mn is between 0.2% and 1% by weight, the amount of Ti is between 0.15% and 0.5% by weight, the amount of Ni is between 0.1% and 0.5% by weight, and the amount of B is between 0.01% and 0.03% by weight. The balance of the alloy is Al.

In another aspect, an article includes the Al base alloy described above. The article includes a first layer fused to a second layer with a high energy density source associated with an additive manufacturing process. After thermal processing the article has at least one mechanical or physical property in or around a fused portion of the article that is substantially equivalent (or better) than Alloy 2219 in a wrought, solution heat-treated, and precipitation-aged condition.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic view of an exemplary embodiment of a particulate feedstock for an additive manufacturing process in accordance with the present disclosure, showing particles formed from an aluminum (Al) base alloy;

FIG. 2 is a schematic view of an article constructed from the Al base alloy of FIG. 1, showing the elements forming the Al base alloy; and

FIG. 3 is a schematic side elevation view of another embodiment of an article including the Al base alloy of FIG. 1, showing a first layer fused to a second layer.

### DETAILED DESCRIPTION OF THE PREFERRED EMBODIMENTS

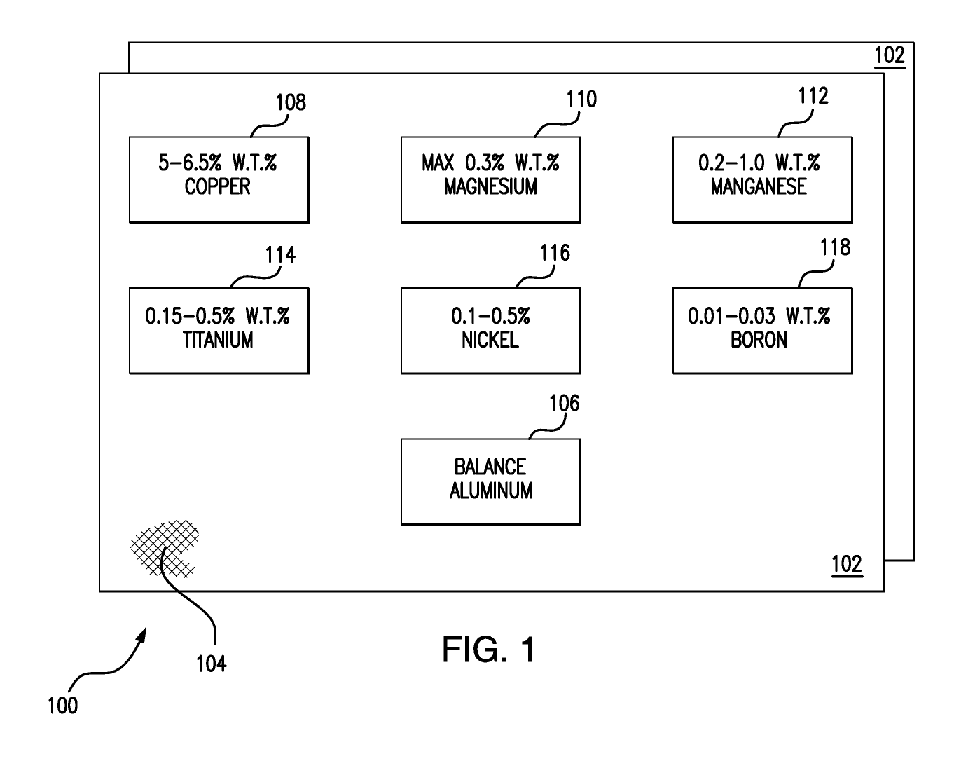

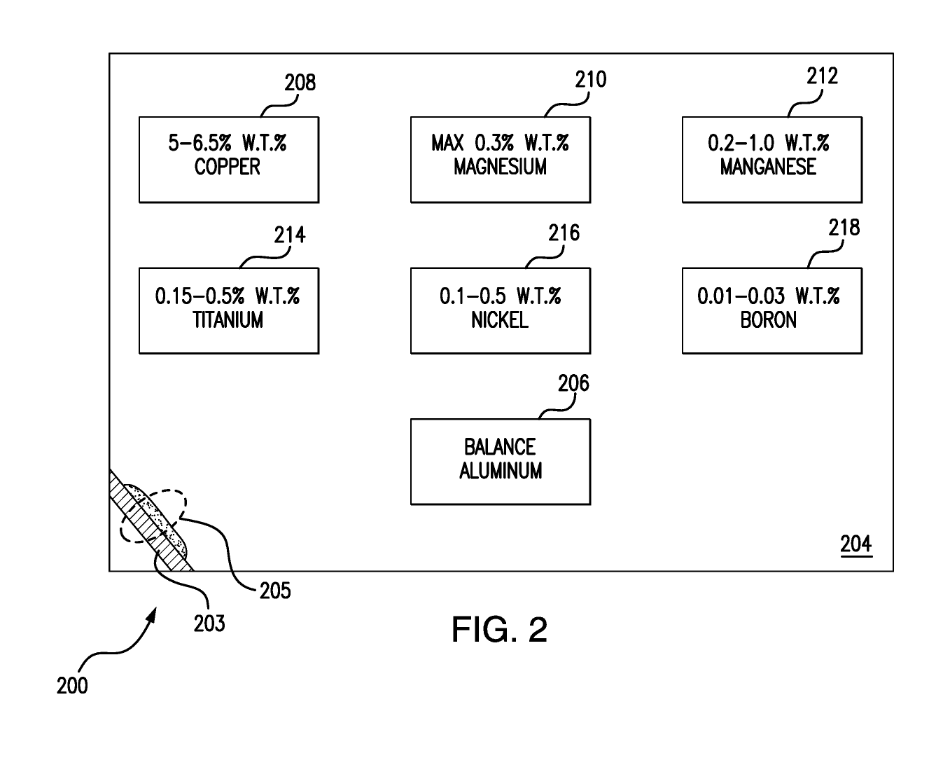

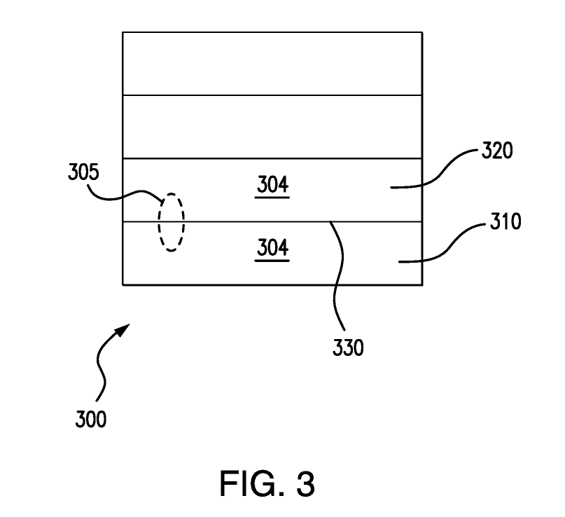

Reference will now be made to the drawings wherein like reference numerals identify similar structural features or aspects of the subject disclosure. For purposes of explanation and illustration, and not limitation, particulate feedstock for an additive manufacturing process according to an exemplary embodiment is shown in FIG. 1 and is designated generally by reference character 100. Other embodiments of feedstock, alloys, and articles formed from such feedstock and alloys in accordance with the disclosure, or aspects thereof, are provided in FIGS. 2-3, as will be described. The particulate feedstock, alloys, and articles formed therefrom described herein can be used to form aluminum (Al) base alloy structures, such as components for aircraft and/or aircraft engines.

Referring now to FIG. 1, particle feedstock 100 for an additive manufacturing process is shown. Particulate feedstock 100 includes a plurality of particles 102 having an alloy 104. Alloy 104 is an Al base alloy, and includes an amount of Cu 108 that is greater than the amounts of the other elements forming alloy 104 as a percentage of the total weight of the alloy. In the illustrated exemplary embodiment, an amount of Al 106 included in alloy 104 is greater than the aggregate amount of each of the other elements included in alloy 104 by weight.

The amount of Cu 108 included in alloy 104 is less than the amount of Al 106 by weight. In the illustrated exemplary embodiment, the amount of Cu 108 included in alloy 104 is between about 5% and about 6.5% by weight. Including amounts of Cu in Al base alloy in this range can improve the corrosion resistance of the alloy in relation to the other Al base alloys have greater amounts of Cu. It can also improve the heat transfer of the alloy in relation to alloys having greater amounts of Cu. As will be appreciated by those of skill in the art in view of the present disclosure, Al base alloys having amounts of Cu in the above range can has lower strength than alloys having greater amounts of Cu.

Al base alloy 104 also includes at an amount of another material including at least one of magnesium (Mg), manganese (Mn), titanium (Ti), nickel (Ni), and/or boron (B). The amount of Cu included in the Al base alloy is greater than the amount of Mg, Mn, Ti, Ni and/or B as percentage of total weight such that the mechanical properties of the Al base alloy, when fused, has mechanical properties substantially the same or better than Alloy 2219. In this respect Al base alloy 104 includes additional elements that improve the strength of the alloy, e.g. respective amounts of Mg and/or Mn, and additional elements that improve the microstructure of the alloy, rendering the material more amenable than other Al base alloys. As will be appreciated, since Al base alloy 104 is configured for fusing, there is no need to include elements incorporated in Al base alloys to facilitate forging, e.g. silicon or vanadium.

As illustrated in FIG. 1, Al base alloy 104 includes an amount of Mg 110. The amount of Mg 110 is less the amount of Cu 108 and functions to improve the strength of Al base alloy 104. In this respect the amount of Mg 110 can offset wholly or in part the strength debit of the alloy relative to Alloy 2219 due to the relatively low Cu content of the alloy. In the illustrated exemplary embodiment the amount of Mg is a non-trace amount of Mg that is less than about 0.3% of the alloy by weight. It is contemplated that, in certain embodiments, substantially no Mg is included in Al base alloy 104.

Al base alloy also includes an amount of Mn 112. The amount of Mn 112 is less than the amount of Cu 108 and functions to improve the strength of Al base alloy 104. In this respect the amount of Mn 112 can offset wholly or in part the strength debit of the alloy relative to Alloy 2219 due to the relatively low Cu content of the alloy. In the illustrated exemplary embodiment the amount of Mn included in Al base alloy 104 is between about 0.2% and about 1% by weight. This can be smaller or greater than the amount of Mg included in Al base alloy 104.

Al base alloy 104 additionally includes a non-trace amount of Ti 114. The amount of Ti 114 is less than the amount of Cu 108 by weight and can be greater than less either or both the amount of Mg 110 and the amount of Mn 112 included in Al base alloy 104. Including Ti in the alloy generally improves the microstructure of Al base alloy 104 by refining the grain size formed within the alloy subsequent to fusing, improving the strength articles portions including fused alloy material. In the illustrated exemplary embodiment Al base alloy 104 includes Ti in an amount between about 0.15% and about 0.5% by weight.

Al base alloy 104 additionally includes a non-trace amount of Ni 116. The amount of Ni 116 is less than the amount of Cu 108 by weight and can be greater than less either or both the amount of Mg 110 and the amount of Mn 112 included in Al base alloy 104. Including Ni in the alloy generally improves the high temperature mechanical properties of Al base alloy 104, rendering articles formed of the alloy suitable for certain high temperature applications. In the illustrated exemplary embodiment Al base alloy 104 includes Ni in an amount between about 0.1% and about 0.5% by weight.

Al base alloy 104 additionally includes a non-trace amount of B 118. The amount of B 118 is less than the amounts of Cu 108, Mg 110, Mn 112, Ti 114, and Ni 116 included in the Al base alloy 104. As with Ti, Including B in the alloy generally improves the microstructure of Al base alloy 104 by refining the grain size formed within the alloy subsequent to fusing, improving the strength articles portions including fused alloy material. Adding both Ti and B to the alloy for this purpose can provide further refinement to the alloy microstructure than would otherwise be obtained using Ti. In the illustrated exemplary embodiment Al base alloy 104 includes B in an amount between about 0.01% and about 0.03% by weight.

With reference to FIG. 2, an article 200 including an Al base alloy 204 is shown. Al base alloy 204 is similar to Al base alloy 104 (shown in FIG. 1), and additionally includes a joint 203. Joint 203 is an area where native material forming article 200 has been joined, such as with a welding or fusion technique. As a result of the joining process, native material including the alloy within joint 203 has been melted and recrystallized, and native material including the alloy adjacent to joint 203 has formed a heat-affected zone. It is contemplated that article 200 can be a component for an aircraft or an aircraft engine like an impeller.

Al base alloy 204 includes each of an amount of Al 206, an amount of Cu 208, an amount of Mg 210, an amount of Mn 212, an amount of Ti 214, an amount of Ni 216, and an amount of B 218. The amount of Cu 208 is between about 5% and about 6.5% by weight. The amount of Mg 210 is less than about 0.3% by weight. The amount of Mn 212 is between about 0.2% and about 1% by weight. The amount of Ti 214 is between about 0.15% and about 0.5% by weight. The amount of Ni 216 is between about 0.1% and about 0.5% by weight. The amount of B 218 is between about 0.01% and about 0.03% by weight. The amount of Al 206 comprises the balance of the alloy and forms the largest portion of the alloy by weight.

Article 200 has one or more properties 205 in and/or around joint 203 after thermal processing that are substantially equivalent or superior to that of Alloy 2219 in a wrought, heat-treated, and precipitation-aged state. For example, property 205 can be a mechanical property such as tensile strength (e.g. ultimate strength, yield strength, or elongation), hardness, shear, fatigue endurance, or a modulus of elasticity. Property 205 may be a physical property, such as density, melting point, coefficient of thermal expansion, or thermal conductivity.

With reference to FIG. 3, an article 300 is shown. Article 300 includes a plurality of layers (e.g. a first layer 310 and a second layer 320) coupled to one another at an interface 330. First layer 310 and second layer 320 comprises particulate feedstock 100 (shown in FIG. 1) fused to one another within the layers and across interface 330 to form an integral structure including Al base alloy 304. Al base alloy 304 is similar to Al base alloy 104 (shown in FIG. 1), and has additionally been exposed to a high energy density source. It is contemplated that the fusing the particulate material includes exposing the particulate a high-density energy source like a laser or an electron beam. The high-density energy source may be an associated with an additive manufacturing technique, such as powder bed fusion.

Article 300 after thermal processing has one or more properties 305 within at least one of the plurality of layers and/or extending across interface 330 that are substantially equivalent or superior to that of Alloy 2219 in a wrought, heat-treated, and precipitation-aged state. As with article 200 (shown in FIG. 2), property 305 can be a mechanical property such as tensile strength (e.g. ultimate strength, yield strength, or elongation), hardness, shear, fatigue endurance, or a modulus of elasticity. Property 305 may be a physical property, such as density, melting point, coefficient of thermal expansion, or thermal conductivity. It is contemplated article 300 may be a homogenous article, meaning that the one or more properties 305 may extend throughout the fused portions of article 300.

Structures formed from some types of aluminum and/or aluminum alloy materials can develop undesirable mechanical properties when joined using conventional welding or fusion processes. Such materials may exhibit hot cracking, increased porosity, and/or dross as a result of undergoing such joining processes, and may exhibit different mechanical and/or physical properties within and/or around the joined portion relative to native portions of the structures. Such structures are therefore generally typically joined using relatively low heat input processes or are preheated prior to undergoing the joining process. The joint site may also require preparation (e.g. cleaning) and/or filler material. While satisfactory for their intended purpose, such materials can be unsuitable for joining using high-energy density processes, such as laser or electron beam source exposure through certain additive manufacturing techniques.

Embodiments of alloys described herein exhibit properties similar or better than conventional alloys like Alloy 2219 and are amenable to high-energy density joining processes, and can therefore enable construction of structures with similar (or better) properties through additive manufacturing techniques formed from Al—Cu alloys. In certain embodiments, the Al—Cu alloys and articles made therefrom are weldable. The Al—Cu alloys may also be of relatively high strength. This can also alloy for fabrication of from Al—Cu alloy using additive manufacturing techniques that are otherwise only available through casting techniques, and with the mechanical and physical properties associated with such techniques.

The methods and systems of the present disclosure, as described above and shown in the drawings, provide for feedstock for additive manufacturing, Al—Cu alloys, and articles with superior properties including improved weldability. While the apparatus and methods of the subject disclosure have been shown and described with reference to preferred embodiments, those skilled in the art will readily appreciate that changes and/or modifications may be made thereto without departing from the scope of the subject disclosure.

1-15. (canceled)

16. A method of making an additively manufactured article, comprising:
fusing particulate to form a first layer, the particulate comprising an aluminum base alloy with predetermined amounts of aluminum (Al) and at least one of copper (Cu), magnesium (Mg), manganese (Mn), titanium (Ti), nickel (Ni), and boron (B), wherein the predetermined amount of Al is greater than the predetermined amount of at least one of Cu, Mg, Mn, Ti, Ni, and B, the predetermined amount of Cu between about 5.0% and about 6.5% of the alloy by weight, the predetermined amount of Ni being less than the predetermined amount of Cu, the non-trace amount of B being less than the amount of Ni, and the predetermined non-trace amount of Mg being less than about 0.3% of the alloy by weight; and
fusing particulate to form a second layer, the second layer fused to the first layer, the particulate comprising the aluminum base alloy,
wherein fusing particulate to form the first layer includes application includes using a high density energy source for a powder bed fusion apparatus, and
wherein fusing particulate to form the first layer includes application includes using a high density energy source for a powder bed fusion apparatus.

17. The method as recited in claim 16, wherein the high density energy source includes a laser.

18. The method as recited in claim 16, wherein the high density energy source includes an electron beam.

19. The method as recited in claim 16, further comprising selecting the predetermined amount of magnesium to provide weldability superior to weldability of Alloy 2219.

20. The method as recited in claim 19, wherein fusing the second layer to the first layer includes defining an interface between the second layer and the first layer, wherein the weldability extends across the interface between the first layer and the second layer.

21. The method as recited in claim 19, wherein fusing the second layer to the first layer includes defining an interface between the second layer and the first layer, wherein weldability of the aluminum base alloy extends across the interface between the first layer and the second layer.

22. The method as recited in claim 16, further comprising welding the fused first and second layers with another structure in a joining operation.

23. The method as recited in claim 16, wherein the aluminum base alloy includes Mn in an amount that is between about 0.2% and about 1% of the alloy by weight.

24. The method as recited in claim 16, wherein the aluminum base alloy includes Ti in an amount between about 0.15% and 0.5% of the aluminum base alloy by weight.

25. The method as recited in claim 16, wherein the aluminum base alloy includes Ni in an amount between about 0.1% and 0.5% of the aluminum base alloy by weight.

26. The method as recited in claim 16, wherein aluminum base alloy includes B in an amount between about 0.01% and 0.03% of the alloy by weight.

27. The method as recited in claim 16, wherein the aluminum base alloy includes both Mg and Mn, wherein the weight of the Mg in the aluminum base alloy is greater than the weight of the Mn in the aluminum base alloy.

28. The method as recited in claim 16, wherein the aluminum base alloy includes an amount Ti and at least one of Ni and B, wherein amount of the amount of Ti in the aluminum base alloy is greater than the weight of the amount of Ni and/or B in the aluminum base alloy.

29. The method as recited in claim 16, wherein the aluminum base alloy includes:
an amount of Mn that is between 0.2% and 1.0% of the aluminum base alloy by weight,
an amount of Ti that is between 0.15% and 0.5% of the aluminum base alloy by weight,
an amount of Ni that is between 0.1% and 0.5% of the aluminum base alloy by weight, and
an amount of B that is between 0.01% and about 0.03% of the aluminum base alloy by weight,
wherein the balance of the aluminum base alloy is Al.
